(19) United States
(12) Patent Application Publication
(10) Pub. No.: US 2014/0170734 A1
(43) Pub. Date: Jun. 19, 2014

(54) NUCLEIC ACID TEST APPARATUS

(71) Applicants: Yoshiyuki Shoji, Tokyo (JP); Takehiko Hosoiri, Tokyo (JP)

(72) Inventors: Yoshiyuki Shoji, Tokyo (JP); Takehiko Hosoiri, Tokyo (JP)

(73) Assignee: HITACHI HIGH-TECHNOLOGIES CORPORATION, Tokyo (JP)

(21) Appl. No.: 14/233,206

(22) PCT Filed: Jun. 25, 2012
(86) PCT No.: PCT/JP2012/066100

§ 371 Date: Jan. 16, 2014

(30) Foreign Application Priority Data
Jul. 25, 2011 (JP) 2011-161530

(51) Int. Cl. B01L 7/00

(52) U.S. Cl. CPC B01L 7/5255
USPC 435/286.2; 435/286.1; 435/287.2

(57) ABSTRACT

The nucleic acid amplification device is configured to amplify the nucleic acid in the reaction solution obtained by mixing a specimen and a reagent and includes a plurality of temperature regulation block configured to hold at least a reaction container provided on a holder base. The order and timings in which the reaction containers are continuously installed on the temperature regulation blocks and in which the temperature regulations of the temperature regulation blocks are started are controlled to minimize the temperature gradient in the holder base.

### TECHNICAL FIELD

The present invention relates to a nucleic acid test apparatus for specimens of biological origin.

### BACKGROUND ART

There is a method, for example, a polymerase chain reaction (hereinafter, referred to as a “PCR”) method as a nucleic acid amplification technique used for a test of the nucleic acid included in a specimen of biological origin. The method specifically amplifies the base sequence to be tested by controlling the temperature of the reaction solution obtained by mixing the specimen and the reagent under a predetermined condition. The method can detect a small amount of nucleic acid at a high sensitivity. Similarly, an isothermal nucleic acid amplification method, for example, a nucleic acid sequence-based amplification (NASBA) method that amplifies the nucleic acid by regulating the reaction solution at a constant temperature is known as another nucleic acid amplification technique. In such nucleic acid amplification methods, many conditions (protocols) such as the reagent to be used, the temperature, and the time vary depending on the measurement item (base sequence to be amplified).

A known conventional technique relating to such a nucleic acid amplification is, for example, a temperature control device that includes a disk-shaped microchip including a cell area to which a reaction solution to be tested is injected. In the temperature control device, the microchip is rotated in a circumference direction in parallel to a stage and is moved to a desired position. The microchip is then put into the stage side with a cover portion such that the cell area of the microchip contacts a plurality of heat conductors provided in the circumference direction of the stage and having different temperatures. As a result, the temperature control device controls the temperature in the cell area (see PTL 1). However, in the conventional technique described in PTL 1, only a measurement item can be measured at a time. Thus, it is difficult in the conventional technique described in PTL 1 to perform parallel processes for a plurality of specimens having different measurement items. Further, it is difficult to start processes for specimens at different times even when the specimens having the same measurement item. Thus, it is difficult to newly start a process for another specimen unless a process currently performed is completed.

### CITATION LIST

### Patent Literature

PTL 1: JP 2008-185389 A

PTL 2: Japanese Patent Application No. 2010-106953

### SUMMARY OF INVENTION

### Technical Problem

When a plurality of specimens having different measurement items is processed in parallel in a nucleic acid amplification as described above, it is necessary to set, for each measurement item, the protocol for each measurement item or, in other words, the temperature and the time specified in a temperature control procedure. The temperature and the time include, for example, a preset temperature and a retention time of the temperature.

When it is possible that a plurality of specimens having different measurement items is processed in parallel and that a process for a specimen is started even when another process is currently performed by individually regulating the temperatures of the reaction solutions in the reaction containers on a plurality of temperature regulation blocks provided on the outer periphery of the disk-shaped holder base using a temperature regulation device including a plurality of Peltier devices.

However, regulating, in the same direction, the temperatures (for example, increasing the temperatures) of the adjacent temperature regulation blocks on the outer periphery of the holder base possibly increases the unevenness of temperature in the holder base because of the exhaust heat from each of the temperature regulation blocks. For example, the temperature in the holder base is locally increased. To resolve such a large unevenness of temperature in the holder base, it is necessary to include a high-performance secondary cooling mechanism to maintain the holder base at a certain temperature range, or to separate the holders by a distance in which the unevenness of temperature becomes equal to or less than a desired value. There is a problem in that the high-performance secondary cooling mechanism requires a large size, a large amount of power, and emits a large amount of heat. Similarly, there is a problem in that increasing the distance between the holders increases the size of the mechanism and thus the mechanism is not suitable for installation on an apparatus. The present invention is made in view of the above problem, and an objective of the present invention is to provide a nucleic acid amplification device that is downsized, and capable of stably controlling the temperature of each reaction containers, and a nucleic acid test apparatus using the nucleic acid amplification device.

### Solution to Problem

To achieve the objective, the present invention provides a nucleic acid amplification device that is configured to amplify the nucleic acid in a reaction solution obtained by mixing a specimen and a reagent and that includes the temperature regulation blocks configured to hold at least one of the reaction containers provided on the outer periphery of the disk-shaped holder base so as to control the order and timing in which the reaction containers are continuously installed on the temperature regulation blocks and in which the temperature regulations of the temperature regulation blocks are started are variously controlled.

### Advantageous Effects of Invention

The present invention can provide a nucleic acid test apparatus that is downsized, is capable of measuring a plurality of measurement items and is capable of stably controlling the temperature of each of the reaction containers.

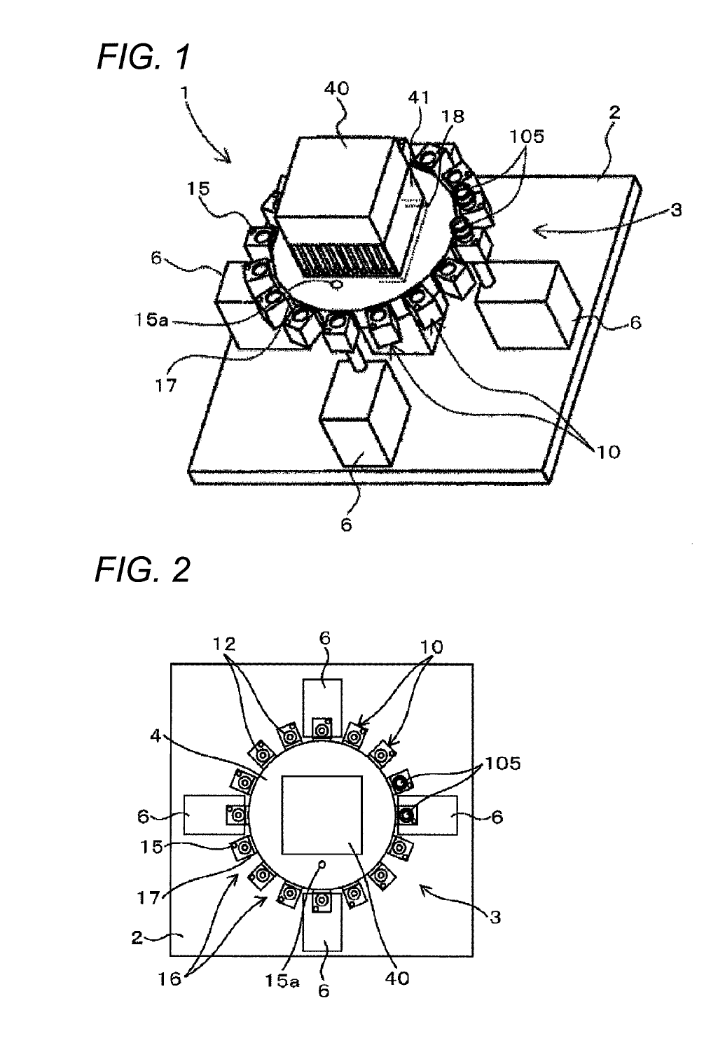

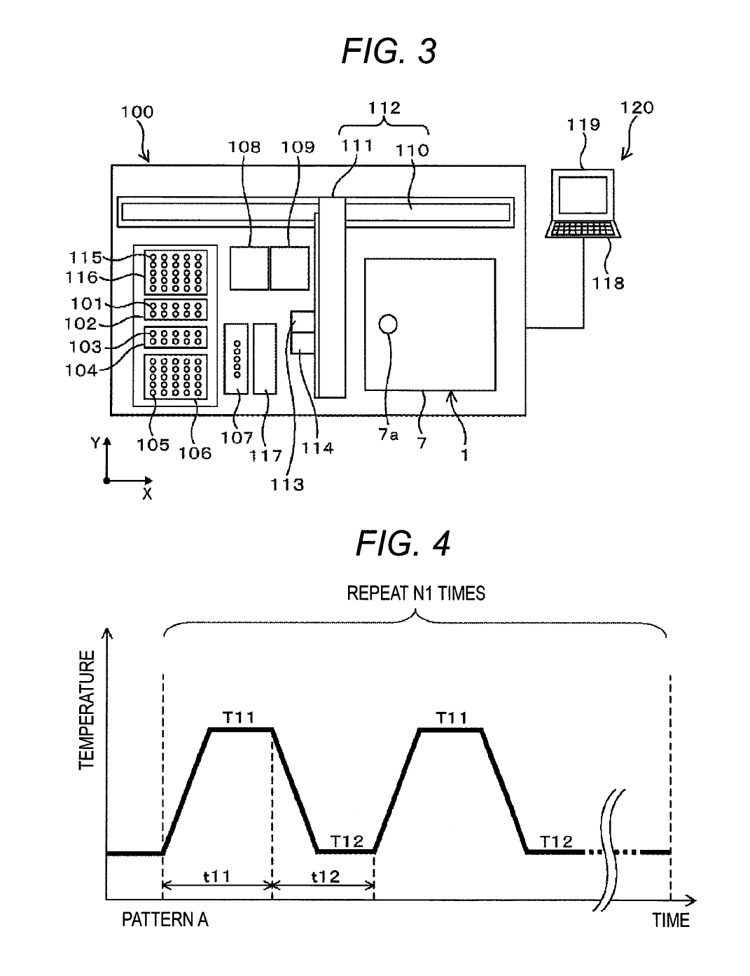

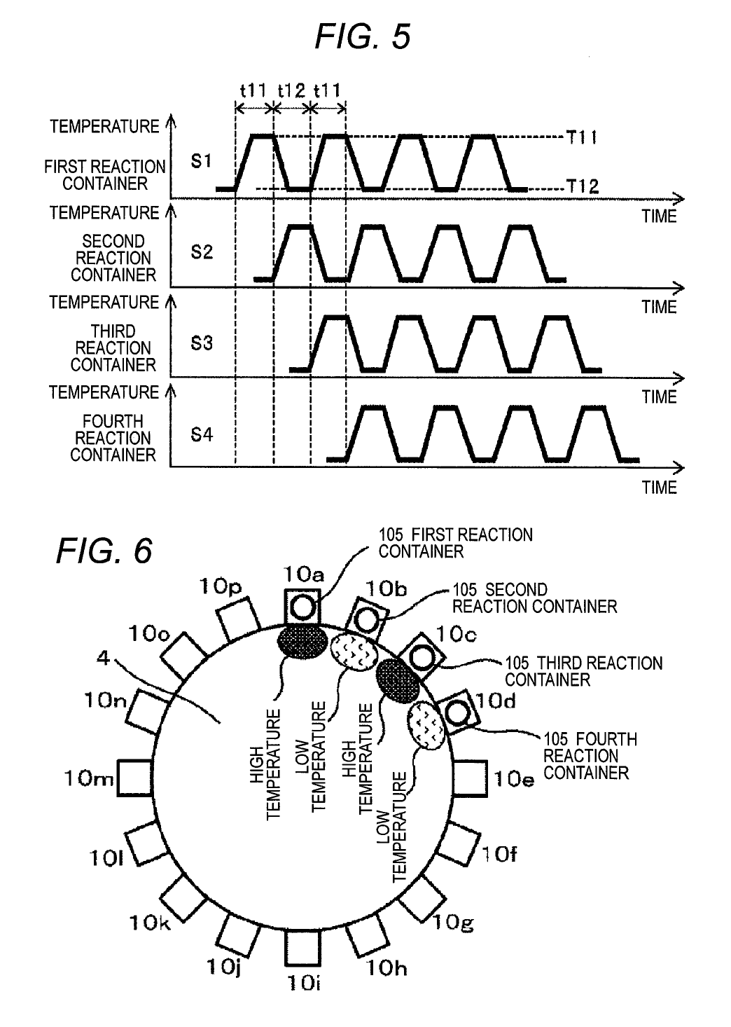

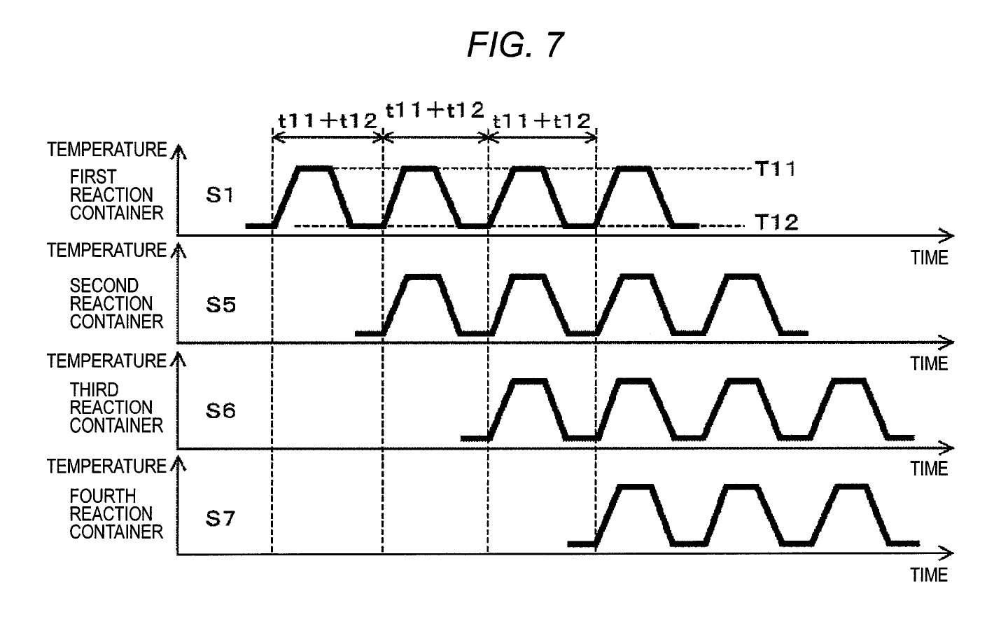

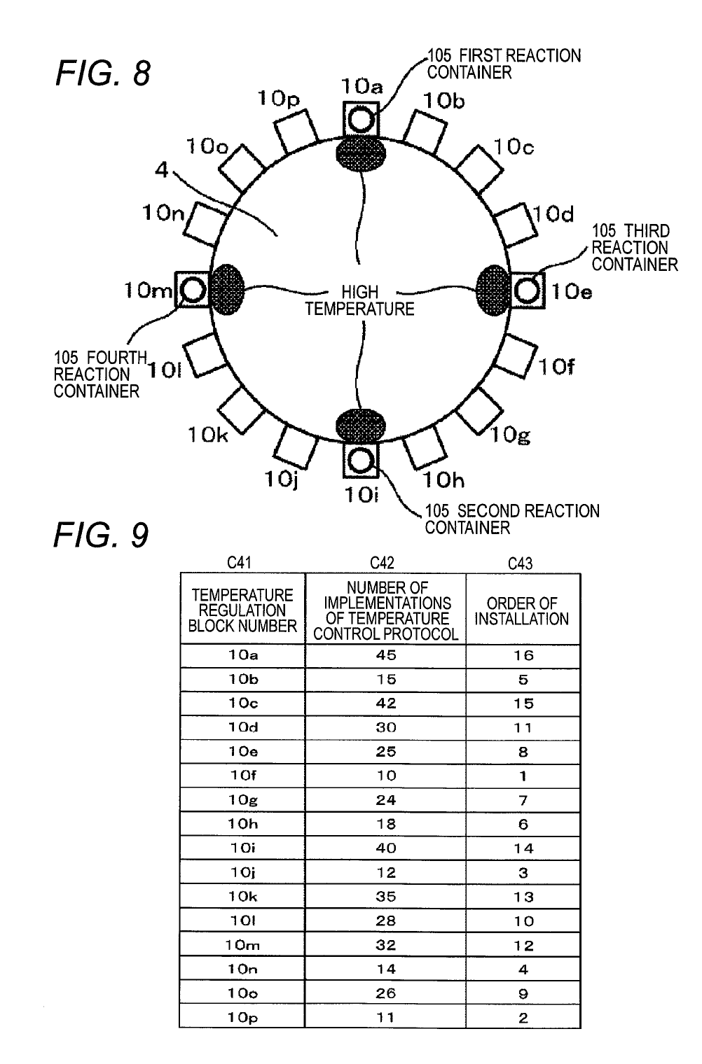

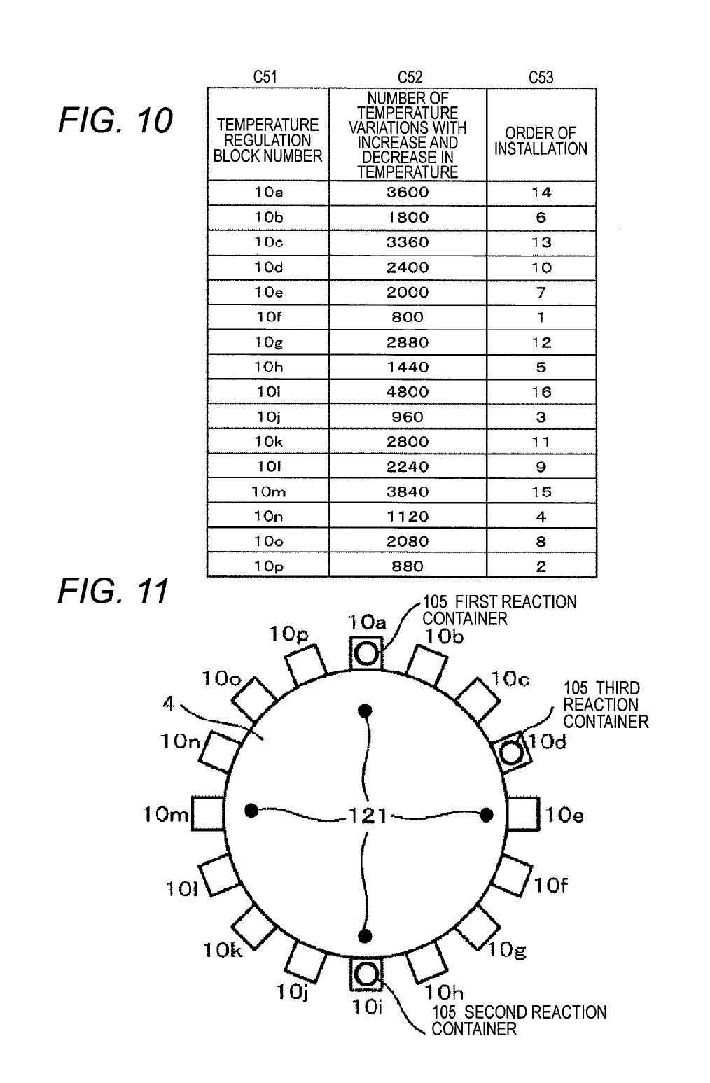

### BRIEF DESCRIPTION OF DRAWINGS

[FIG. 1] FIG. 1 is a perspective diagram of a schematic configuration of a nucleic acid amplification device according to embodiments of the present invention.

[FIG. 2] FIG. 2 is a top view of a schematic configuration of the nucleic acid amplification device according to the embodiments of the present invention.

[FIG. 3] FIG. 3 is a schematic diagram illustrating the whole configuration of a nucleic acid test apparatus according to the embodiments of the present invention.

[FIG. 4] FIG. 4 is a diagram conceptually illustrating an exemplary temperature control in a nucleic acid amplification process (pattern A).

[FIG. 5] FIG. 5 is a diagram conceptually illustrating temperature variations of the reaction solutions in temperature regulation blocks according to first and third embodiments of the present invention during the temperature control in the pattern A.

[FIG. 6] FIG. 6 is a diagram conceptually illustrating the temperature distribution and the installation positions of reaction containers on a holder base during the temperature control for amplification reactions according to the first and third embodiments of the present invention.

[FIG. 7] FIG. 7 is a diagram conceptually illustrating temperature variations of the reaction solutions in temperature regulation blocks according to a second embodiment of the present invention during the temperature control in the pattern A.

[FIG. 8] FIG. 8 is a diagram conceptually illustrating the temperature distribution and the installation positions of reaction containers on a holder base during the temperature control for amplification reaction according to the second embodiment of the present invention.

[FIG. 9] FIG. 9 is a diagram illustrating an example of the numbers of implementations of temperature control of the temperature regulation blocks according to a fourth embodiment of the present invention and the order of installation according to the numbers.

[FIG. 10] FIG. 10 is a diagram illustrating an example of the numbers of temperature variations of the temperature regulation blocks according to a fifth embodiment of the present invention and the order of installation according to the numbers.

[FIG. 11] FIG. 11 is a diagram of an exemplary holder base according to a seventh embodiment of the present invention.

### DESCRIPTION OF EMBODIMENTS

Hereinafter, the embodiments of the present invention will be described with reference to the appended drawings.

### First Embodiment

FIG. 3 is a schematic diagram illustrating the whole configuration of a nucleic acid test apparatus 100 according to the present embodiment. As illustrated in FIG. 3, the nucleic acid test apparatus 100 includes a plurality of sample containers 101 each configured to house a specimen including nucleic acid to be amplified, a sample container rack 102 configured to house the sample containers 101, a plurality of reagent containers 103 configured to house various reagents to be added to specimens, a reagent container rack 104 configured to house the reagent containers 103, a reaction container 105 configured to mix a specimen with a reagent, a reaction container rack 106 configured to house a plurality of unused reaction containers 105, a reaction solution regulation position 107 configured to dispense a specimen and a reagent from the sample container 101 and the reagent container 103 to an unused reaction container 105 with placing the container 105 thereon, a capping unit 108 configured to seal, with a cover portion (not illustrated in the drawings), the reaction container 105 housing the reaction solution that is a mixture of a specimen and a reagent, and an agitation unit 109 configured to agitate the reaction solution housed in the sealed reaction container 105.

The nucleic acid test apparatus 100 further includes a robotic arm device 112 that includes a robotic arm X shaft 110 extending on the nucleic acid test apparatus 100 in an X-axis direction (the horizontal direction in FIG. 3), and a robotic arm Y shaft 111 extending in a Y-axis direction (the vertical direction in FIG. 3) and provided on the robotic arm X shaft 110 so as to be capable of moving in the X-axis direction; a gripper unit 113 provided on the robotic arm Y shaft 111 so as to be capable of moving in the Y-axis direction and configured to grip and convey the reaction container 105 to each part in the nucleic acid test apparatus 100; a dispensing unit 114 provided on the robotic arm Y shaft 111 so as to be capable of moving in the Y-axis direction and configured to aspirate and eject (dispense) the specimen in the sample container 101 or the reagent in the reagent container 103 to the reaction container 105 placed on the reaction solution regulation position 107; a nozzle chip 115 configured to be installed at a portion in which the nozzle chip contact the specimen or reagent in the dispensing unit 114; a nozzle chip rack 116 configured to house a plurality of unused nozzle chips 115; a nucleic acid amplification device 1 configured to provide a nucleic acid amplification process or a fluorescence detection to the reaction solution housed in the reaction container 105; a disposal box 117 to which a used nozzle chip 115 or a used (tested) reaction container 105 is discarded; and a control device 120 that includes an input device 118 including a keyboard and a mouse, and a display device 119 including a liquid crystal monitor, and that is configured to control all the operations in the nucleic acid test apparatus 100 including the nucleic acid amplification device 1.

Each of the sample containers 101 is managed using identification data for each of the housed specimens, for example, a bar code, and is managed using positional information, for example, coordinates allotted to each position in the sample container rack 102. Similarly, each of the reagent containers 103 is managed using identification data for each of the housed reagents, for example, a bar code, and is managed using positional information, for example, coordinates allotted to each position in the reagent container rack 104. The identification data and the positional information are previously registered and are managed in the control device 120. Each of the reaction containers 105 is similarly managed using the identification data or the positional information.

Next, the nucleic acid amplification device 1 will be described in detail with reference to FIGS. 1 and 2.

FIG. 1 is a perspective diagram of a schematic configuration of the nucleic acid amplification device 1 according to an embodiment of the present invention, and FIG. 2 is a top view thereof.

As illustrated in FIGS. 1 and 2, a holder 3 according to the present embodiment includes a disk-shaped holder base 4 of which planar portion is placed upward, and a plurality of (16 in the present embodiment) temperature regulation blocks 10 each having at least one (one in the present embodiment) installation position 12 configured to hold the reaction container 105 provided outside the outer periphery of the holder base 4 in a circumferential direction. The holder base 4 can turn around the central shaft provided along the rotational axis on the holder 3. A stepping motor (not illustrated in the drawings) provided between the holder 3 and the holder base 4 drives and turns the holder base 4. The holder base 4 and the temperature regulation blocks 10 are made of, for example, a thermal conductor such as aluminum, copper, or each of various alloys. The temperature regulation blocks 10 are integrally formed with the holder base 4. Notched portions 16 each extending from the outer periphery to the center of the holder base 4 are provided between the temperature regulation blocks 10 in the circumferential direction of the holder base 4. Providing a space between the adjacent temperature regulation blocks 10 arranged in the circumferential direction of the holder base 4 increases the adiabatic effect at each space between the temperature regulation blocks 10. Each of the temperature regulation blocks 10 includes a Peltier device 17 working as a temperature regulation device, and a temperature sensor 15 configured to detect the temperature of the reaction solution in the reaction container 105 by detecting the temperature near the installation position 12. The Peltier device 17 is installed on the temperature regulation block 10 while the first surface of two surfaces between which a heat exchange is generated coheres with the temperature regulation block 10 and the second surface coheres with the holder base 4.

A Peltier device 18 working as a temperature regulation device, a temperature sensor 15a configured to detect the temperature therearound, a heat radiation fin 41 connected to the Peltier device 18, and a fan 40 configured to blow air to the heat radiation fin 41 are provided at the center of the holder base 4. Thus, maintaining the holder base 4 at a constant temperature (for example, 40° C.) using the Peltier device 18 can improve the efficiency of heat radiation and heat absorption of the Peltier devices 17 in the temperature regulation blocks 10. While a specified temperature cycle in which the temperature in the temperature regulation block 10 increases and decreases is repeated in the reaction container during the implementation of a PCR method that is a nucleic acid amplification method, appropriately setting the temperature of the holder base 4 increases the rate of change of the temperature such that the balance between the ascent rate and descent rate in temperature can be controlled.

The nucleic acid amplification device 1 includes at least a fluorescence detector 6 (four in the present embodiment) configured to provide a fluorescence detection to the reaction solution housed in the reaction container 105, and a cover 7 (see FIG. 3) covering the whole of the nucleic acid amplification device 1. The cover 7 is designed to shield the fluorescence detector 6 of the nucleic acid amplification device 1 from outside light, or to keep warm in the nucleic acid amplification device 1 (under the cover 7), by covering the temperature regulation blocks 10 and the fluorescence detector 6 together with the holder 3. The cover 7 is provided with at least a (one in the present embodiment) gate 7a capable of opening and closing, and through which the reaction container 105 is passed into or out of the cover 7 (namely, into or out of the nucleic acid amplification device 1). Note that the cover 7 and the gate 7a are omitted in FIG. 1.

The fluorescence detector 6 includes an excitation light source for emitting an excitation light to the lower portion (exposed portion) of the reaction container 105 held in the installation position 12 of the temperature regulation block 10, and a detection device for detecting the fluorescence from the reaction solution (both are not illustrated in the drawings). The excitation light source and the detection device are placed next to each other along the outer periphery of the traffic line of the temperature regulation block 10 that moves on the same circle due to the turn and drive of the holder base 4. Turning the holder base 4 passes the reaction container 105 held in the temperature regulation block 10 through the detection position so as to provide the fluorescence detection to the reaction container 105. The base sequence to be amplified in the reaction solution housed in the reaction container 105 is labeled by fluorescence labeling using the reagent. Detecting the fluorescence from the reaction solution caused by the excitation light emitted from the excitation light source to the reaction container 105 in the fluorescence detector 6 temporally determines the quantity of the base sequence to be amplified in the reaction solution. The fluorescence detectors 6 detect or measure the reaction solution in the reaction container 105, independently of each other. The detection result is transmitted to the control device 120. For example, a light-emitting diode (LED), a gas laser, a semiconductor laser, a xenon lamp, or a halogen lamp can be used as the excitation light source. For example, a photodiode, a photomultiplier, or a CCD can be used as the detection device.

The control device 120 is configured to control all the operations in the nucleic acid test apparatus 100. The control device 120 provides the nucleic acid amplification process or the fluorescence detection using various types of software previously stored in a storage unit (not illustrated in the drawings) and based on the protocols of the measurement items set using the input device 118, and has functions, for example, for storing analyses including a fluorescence detection result and the working conditions of the nucleic acid test apparatus 100, and for displaying them on the display device 119.

In the nucleic acid amplification process performed in the nucleic acid amplification device 1 of the nucleic acid test apparatus 100 as described above, the temperature of the specimen (the reaction solution housed in the reaction container 105) prepared in a manner specified in the protocol determined according to the measurement item is controlled according to the protocol. This selectively amplifies the base sequence to be tested.

Note that, although the excitation light is emitted from the lower portion of the reaction container 105 held in the installation position 12 of the temperature regulation block 10 so as to detect the fluorescence in the embodiments of the present invention, the emission is not limited to the embodiments. The excitation light can be emitted and the fluorescence can be detected from the side or upper portion of the reaction container 105. Further, the excitation light can be emitted from one of the lower portion, upper portion and side of the reaction container 105 such that the fluorescence can be detected from a direction different from the direction in which the excitation light is emitted.

The numbers of the fluorescence detectors 6, the temperature regulation blocks 10, and the gates 7a are not limited to the numbers described in the present embodiment. The numbers can be adjusted as necessary.

In an installation process of the reaction container 105, the gripper unit 113 included in the robotic arm device 112 as illustrated in FIG. 3 grips the reaction container 105 on the agitation unit 109 to pass the reaction container 105 through the gate 7a so as to install the reaction container 105 in the installation position 12 on the temperature regulation block 10 in the nucleic acid amplification device 1. After the reaction container 105 is installed on the temperature regulation block 10, the Peltier device 17 controls the temperature for an amplification reaction. However, the Peltier device 17 also controls the temperature of the temperature regulation block 10 before the amplification reaction (preheat) even before the installation. The installation process and temperature control of the reaction container 105 to be described below are similarly performed.

Next, the temperature control in the nucleic acid amplification process according to the present embodiment will be described with reference to FIG. 4.

FIG. 4 conceptually illustrates an exemplary temperature control protocol in the nucleic acid amplification process as a pattern A.

<Temperature Control: Pattern A>

The temperature of the reaction solution in the reaction container 105 is controlled as described below by the control of the Peltier device 17 contacting the temperature regulation block 10 on which the reaction container 105 is installed in the nucleic acid amplification device 1.
The temperature is changed (increased) to a temperature T11 and maintained at the temperature T11 for a time t11. The time t11 includes the time required to change the temperature from a previous temperature to the temperature T11.
The temperature is changed (reduced) to a temperature T12 and maintained at the temperature T12 for a time t12. The time t12 includes the time required to change the temperature from a previous temperature to the temperature T12.
The processes are combined as a cycle. The cycle is repeated times (N1) specified in the temperature control protocol.

When the temperature control protocol specifies a cycle other than the above-mentioned temperature cycle, the temperature and the time are set following the above-mentioned cycle.

Next, a method for controlling a position in which the reaction container 105 is to be installed in the nucleic acid amplification device 1 according to the present embodiment will be described with reference to FIGS. 5 and 6.

In the temperature control in the pattern A, for example, when the time t11 is almost the same as the time t12, and each of the time intervals (timings) at which a plurality of reaction containers 105 is continuously installed on a plurality of the temperature regulation blocks 10 is almost the same as the time t11, in other words, the reaction container 105 is installed every the time t11; the temperature of the temperature regulation block 10 of a first reaction container that is installed first is controlled such that the reaction solution in the first reaction container shows the temperature profile illustrated as S1 in FIG. 5. A second reaction container is installed after the time t11 has elapsed since the installation of the first reaction container, and shows the temperature profile illustrated as S2. Similarly, a third reaction container shows the temperature profile illustrated as S3, and a fourth reaction container shows the temperature profile illustrated as S4. As a result, the temperature regulation blocks 10 on which the reaction containers 105 are installed have alternately high temperatures (temperatures T11) and low temperatures (temperature T12.) at the same time. Thus, under the above-mentioned conditions, the positions at which the reaction containers 105 are installed are controlled such that the first reaction container is installed on a temperature regulation block 10a, the second reaction container is installed on a temperature regulation block 10b, the third reaction container is installed on a temperature regulation block 10c, and the fourth reaction container is installed on a temperature regulation block 10d as illustrated in FIG. 6. This causes the adjacent temperature regulation blocks 10 to alternately have the high temperatures (temperatures T11) and the low temperatures (temperature T12). As a result, the high temperatures and the low temperatures are alternately placed on the temperature distribution on the holder base 4. This averages the unevenness of temperature on the whole holder base 4. Controlling the installation positions as described above reduces the load on the Peltier device 18 provided at the center of the holder base 4, the heat radiation fin 41 connected to the Peltier device 18, and the fan 40 blowing air to the heat radiation fin 41. In light of the performance of each component, a downsized mechanism with lower power consumption and a small amount of waste heat can be selected.

Note that, although the nucleic acid amplification device 1 in FIG. 1 and the temperature control pattern in FIG. 4 are described as an example of the control of the order of installation positions in the present embodiment, the order is not limited to the present embodiment. The order of installation positions can be controlled in the same manner even in a nucleic acid amplification device having a different number of installation positions (the number of temperature regulation blocks) or even in another temperature control pattern. Although the temperature regulation block 10a is the first installation position, any of the other temperature regulation blocks 10 can be the first installation position.

### Second Embodiment

The method for controlling the positions at which the reaction containers 105 are installed in the nucleic acid amplification device 1 in FIG. 1 will be described in the second embodiment of the present invention with reference to FIGS. 7 and 8.

In the temperature control of the pattern A, for example, when the time t11 is almost the same as the time t12, and each of the time intervals (timings) at which a plurality of reaction containers 105 is continuously installed on a plurality of the temperature regulation blocks 10 is almost the same as a time obtained by adding the time t11 to the time t12, in other words, the reaction container 105 is installed every the time (the time t11+the time t12); the temperature of the temperature regulation block 10 of a first reaction container that is installed first is controlled such that the reaction solution in the first reaction container shows the temperature profile illustrated as S1 in FIG. 7. A second reaction container is installed after the time (the time t11+the time t12) has elapsed since the installation of the first reaction container, and shows the temperature profile illustrated as S5. Similarly, a third reaction container shows the temperature profile illustrated as S6, and a fourth reaction container shows the temperature profile illustrated as S7. As a result, the temperature regulation blocks 10 on which the reaction containers 105 are installed all have high temperatures (temperatures T11) or all have low temperatures (temperature T12) at the same time. Thus, under the above-mentioned conditions, the positions at which the reaction containers 105 are installed are controlled such that the first reaction container is installed on a temperature regulation block 10a, the second reaction container is installed on a temperature regulation block 10i, the third reaction container is installed on a temperature regulation block 10e, and the fourth reaction container is installed on a temperature regulation block 10m as illustrated in FIG. 8. This controls the containers to be installed on the temperature regulation blocks at the positions separated from each other such that the positions of the containers disperse on the holder base 4. Thus, the high temperatures and the low temperatures are evenly placed on the temperature distribution on the holder base 4. Such a control of the installation positions provides a similar effect to the first embodiment.

Note that, although the nucleic acid amplification device 1 in FIG. 1 and the temperature control pattern in FIG. 4 are described as an example of the control of the order of installation positions in the present embodiment, the order is not limited to the present embodiment. The order of installation positions can be controlled in the same manner even in a nucleic acid amplification device having a different number of installation positions (the number of temperature regulation blocks) or even in another temperature control pattern. Although the temperature regulation block 10a is the first installation position, any of the other temperature regulation blocks 10 can be the first installation position.

### Third Embodiment

The timings for installing the reaction containers 105 and the method for controlling the positions at which the reaction containers 105 are installed in the nucleic acid amplification device 1 illustrated in FIG. 1 will be described in the third embodiment of the present invention with reference to FIGS. 5 and 6.

In the temperature control in the pattern A, for example, when the time t11 is almost the same as the time t12, and the time intervals at which a plurality of reaction containers 105 is continuously installed on a plurality of the temperature regulation blocks 10 can freely be set, the timing for installing the next reaction container 105 is automatically controlled such that the timing is set at the time after the time t11 has elapsed according to the determination from each piece of the information about the temperature control protocol stored in the control device 120. As a result, the reaction solution in each of the first reaction containers 105 shows the temperature profile as illustrated in FIG. 5. Further, the positions at which the reaction containers 105 are installed are controlled such that the first reaction container is installed on a temperature regulation block 10a, the second reaction container is installed on a temperature regulation block 10b, the third reaction container is installed on a temperature regulation block 10c, and the fourth reaction container is installed on a temperature regulation block 10d as illustrated in FIG. 6. This causes the adjacent temperature regulation blocks 10 to alternately have the high temperatures (temperatures T11) and the low temperatures (temperature T12) As a result, the high temperatures and the low temperatures are alternately placed on the temperature distribution on the holder base 4. This averages the unevenness of temperature on the whole holder base 4. The installation timings and the control of the installation positions provide a similar effect to the first embodiment.

Note that, although the nucleic acid amplification device 1 in FIG. 1 and the temperature control pattern in FIG. 4 are described as examples of the installation timings and the control of the order of installation positions in the present embodiment, the timing and the order are not limited to the present embodiment. The installation timings and the order of installation positions can be set and controlled in the same manner even in a nucleic acid amplification device having a different number of installation positions (the number of temperature regulation blocks) or even in another temperature control pattern. Although the temperature regulation block 10a is the first installation position, any of the other temperature regulation blocks 10 can be the first installation position.

### Fourth Embodiment

The method for controlling the positions at which the reaction containers 105 are installed in the nucleic acid amplification device 1 illustrated in FIG. 1 will be described in the fourth embodiment of the present invention with reference to FIG. 9.

A nucleic acid test apparatus 100 stores the history of the frequency of usage (the number of implementations) of each temperature regulation block 10 in a control device 120. At the next time the nucleic acid test apparatus 100 is operated, the order of usage of the temperature regulation blocks 10 can be controlled based on the history of the number of implementations. As illustrated at C42 in FIG. 9, the data of the number of implementations of the temperature control protocol for each of the temperature regulation blocks 10a to 10p is stored in the control device 120. At the next time the temperature control protocols are implemented, the reaction containers 105 are installed on the temperature regulation blocks 10 in order of increasing in the number of implementations (at C43 in FIG. 9). Such a control of the installation positions can average the frequency of operation of Peltier devices 17 that are temperature regulation devices included in the temperature regulation blocks 10. This can prolong the life of the whole nucleic acid amplification device. Further, when the difference between the numbers of implementations of the temperature control protocols of the temperature regulation blocks 10 becomes equal to or more than a predetermined number, the control device 120 can generate an alarm to display the alarm on a display device 119.

Note that, although the nucleic acid amplification device 1 in FIG. 1 is described as an example in the present embodiment, the present invention is not limited to the present embodiment. The order of installation positions can be controlled in the same manner even in a nucleic acid amplification device having a different number of installation positions (the number of temperature regulation blocks).

### Fifth Embodiment

The method for controlling the positions at which the reaction containers 105 are installed in the nucleic acid amplification device 1 illustrated in FIG. 1 will be described in the fifth embodiment of the present invention with reference to FIG. 10.

A nucleic acid test apparatus 100 stores the history of the frequency of increase and decrease in the temperature (the number of temperature variations) of each temperature regulation block 10 in a control device 120. At the next time the nucleic acid test apparatus 100 is operated, the order of usage of the temperature regulation blocks 10 can be controlled based on the history of the number of temperature variations. As illustrated at C52 in FIG. 10, the data of the number of temperature variations with increase and decrease in the temperature of each of the temperature regulation blocks 10a to 10p is stored in the control device 120. At the next time the temperature control protocols are implemented, the reaction containers 105 are installed on the temperature regulation blocks 10 in order of increasing in the number of temperature variations of the temperature regulation blocks 10 (at C53 in FIG. 10). Such a control of the installation positions provides the similar effect to the fourth embodiment. Further, when the difference between the numbers of temperature variations of the temperature regulation blocks 10 becomes equal to or more than a predetermined number in the temperature control protocols, the control device 120 can generate an alarm to display the alarm on a display device 119.

Note that, although the nucleic acid amplification device 1 in FIG. 1 is described as an example in the present embodiment, the present invention is not limited to the present embodiment. The order of installation positions can be controlled in the same manner even in a nucleic acid amplification device having a different number of installation positions (the number of temperature regulation blocks).

### Sixth Embodiment

Setting a temperature regulation block 10 used to install a reaction container 105 according to the input from an input device 118 can arbitrarily determine the temperature regulation block 10 to be used for measurement from among a plurality of temperature regulation blocks 10 in a nucleic acid test apparatus 100. Similarly, setting a temperature regulation block 10 that is not to be used to install a reaction container 105 from the input device 118 can arbitrarily determine the temperature regulation block 10 that is not to be used for measurement from among a plurality of temperature regulation blocks 10. Further, the order of usage of the temperature regulation blocks 10 to be used can be input and set from the input device 118. Such a function enables the user of the apparatus to freely select a temperature regulation block 10 to be used for measurement and set the order of usage.

### Seventh Embodiment

The configuration of the holder base 4 in the nucleic acid amplification device 1 in FIG. 1 will be described in the seventh embodiment of the present invention with reference to FIG. 20. At least a temperature measurement unit configured to measure the temperature at each point on a holder base 4 is installed on a holder base 4. Four temperature measurement units are installed in the present embodiment. The temperature measurement unit is, for example, a resistance temperature detector or a thermistor. The temperature measurement units are preferably installed at the same distance from the center of the holder base 4. However, depending on the shape of the holder base, or when there is a handling logic after the temperature measurement, the installation is not limited to the present embodiment. The installation in the horizontal direction is described above. However, the installation in the vertical direction is similar to the above.

### Eighth Embodiment

A method for controlling the temperature on the holder base 4 in the nucleic acid amplification device 1 in FIG. 1 will be described in the eighth embodiment of the present invention with reference to FIGS. 1, 2 and 3.

As described in the first embodiment of the present invention, maintaining the holder base 4 at a constant temperature (for example, 40° C.) can effectively improve the efficiency of heat radiation and heat absorption of the Peltier devices 17 that controls the temperature in the temperature regulation blocks 10. However, it is necessary to previously maintain the holder base 4 at a desired temperature (for example, 40° C.) before the temperature of the temperature regulation block 10 is controlled according to the temperature control protocol for a nucleic acid amplification process (the preheat of the holder base 4) because the holder base 4 in the nucleic acid amplification device 1 has a room temperature just after the nucleic acid test apparatus 100 has been activated.

The temperature preferably reaches the desired temperature for as short a time as possible because the preheat time is included in the preparation time required before the nucleic acid amplification device 1 operates.

Normally, the Peltier device 18 placed on the upper portion of the holder base 4 singularly controls the temperature of the holder base 4. The Peltier device 17 does not control the temperature of the temperature regulation block 10 at the time when the apparatus is activated. Thus, controlling all or some of the Peltier devices 17 (16 Peltier devices 17 in the present embodiment as illustrated in FIGS. 1 and 2) with the second surface of the heat exchange surfaces cohering with the holder base 4 can secondarily control the temperature of the holder base 4.

According to the present embodiment, controlling the temperature of the holder base 4 using both of the Peltier device 18 and at least a Peltier device 17 can bring the holder base 4 to a desired temperature in a shorter time than when the Peltier device 18 singularly controls the temperature of the holder base 4.

In the present embodiment, the time when the apparatus is activated is described. However, the present invention is not limited to the time when the apparatus is activated. When there are one or more Peltier devices 17 that do not control the temperatures of the temperature regulation blocks 10, the one or more Peltier devices 17 can secondarily control the temperature of the holder base 4 as necessary in any condition of the nucleic acid amplification device 1.

### REFERENCE SIGNS LIST

1 nucleic acid amplification device
2 base
3 holder
4 holder base
6 fluorescence detector
7 cover
7a gate
10, 10a, 10b, 10c, 10d, 10e, 10f, 10g, 10h, 10i, 10j, 10k, 10l, 10m, 10n, 10o, 10p temperature regulation block
12 installation position
15, 15a, 121 temperature sensor
16 notched portion
17, 18 peltier device
40 fan
41 heat radiation fin
100 nucleic acid test apparatus
101 sample container
102 sample container rack
103 reagent container
104 reagent container rack
105 reaction container
106 reaction container rack
107 reaction solution regulation position
108 capping unit
109 agitation unit
110 robotic arm X shaft
111 robotic arm Y shaft
112 robotic arm device
113 gripper unit
114 dispensing unit
115 nozzle chip
116 nozzle chip rack
117 disposal box
118 input device
119 display device
120 control device

1. A nucleic acid test apparatus configured to amplify and detect nucleic acid in a reaction solution obtained by mixing a specimen and a reagent, the nucleic acid test apparatus comprising:
a plurality of temperature regulation blocks each configured to hold at least a reaction container that houses the reaction solution;
a first temperature regulation device provided at each of the temperature regulation blocks and configured to regulate a temperature of the reaction solution;
a holder base configured to hold the temperature regulation blocks;
a second temperature control device provided at the holder base and configured to regulate a temperature of the holder base; and
a control unit configured to control timings of inputs of the reaction containers so as to reduce a temperature gradient in the holder base.

2. The nucleic acid test apparatus according to claim 1, wherein, at an input of a plurality of reaction containers of which temperatures are controlled to repeat high temperatures and low temperatures in a same period of time and a same cycle,
the reaction containers are input such that reaction containers having a high temperature and reaction containers having a low temperature are alternately arranged during the temperature control.

3. The nucleic acid test apparatus according to claim 1, further comprising:
an arm configured to input the reaction containers into the temperature regulation blocks,
wherein the control unit controls the arm based on a temperature regulation block to which a reaction container is input and a timing of the input.

4. The nucleic acid test apparatus according to claim 1, wherein, at an input of a plurality of reaction containers of which temperatures are controlled to repeat high temperatures and low temperatures in a same period of time and a same cycle, the reaction containers are input such that reaction containers having high temperatures or low temperatures are not alternately arranged at the same time during the temperature control.

5. The nucleic acid test apparatus according to claim 1, wherein, when a second reaction container is subsequently input after a first reaction container has been input, the second reaction container is input at a temperature regulation block placed farthest from the first reaction container.

6. The nucleic acid test apparatus according to claim 1, wherein the control unit reduces a temperature gradient by controlling positions to which the reaction containers are to be input.

7. The nucleic acid test apparatus according to claim 1, wherein the control unit reduces a temperature gradient by controlling timings of inputs of the reaction containers.

8. The nucleic acid test apparatus according to claim 1, wherein a position of a temperature regulation block at which the reaction container is installed first is arbitrarily selected.

9. A nucleic acid test apparatus configured to amplify and detect nucleic acid in a reaction solution obtained by mixing a specimen and a reagent, the nucleic acid test apparatus comprising:
a plurality of temperature regulation blocks each configured to hold at least a reaction container that houses the reaction solution;
a first temperature regulation device provided at each of the temperature regulation blocks and configured to regulate a temperature of the reaction solution;
an arm configured to input reaction containers to the temperature regulation blocks; and
a control unit configured to control the arm based on a temperature regulation block to which a reaction container is input and a timing of the input,
wherein, when the reaction containers are continuously installed to the temperature regulation blocks, temperatures of the temperature regulation blocks to which the reaction containers are installed are controlled with the first temperature regulation devices according to temperature control protocols determined according to measurement items of the reaction containers, and
a selection of a position of the temperature regulation block to which a next reaction container of the reaction containers is installed is controlled depending on a number of implementations of the temperature control protocols of the temperature regulation blocks in the past.

10. A nucleic acid test apparatus configured to amplify and detect nucleic acid in a reaction solution obtained by mixing a specimen and a reagent, the nucleic acid test apparatus comprising:
a plurality of temperature regulation blocks each configured to hold at least a reaction container that houses the reaction solution;
a first temperature regulation device provided at each of the temperature regulation blocks and configured to regulate a temperature of the reaction solution;
an arm configured to input reaction containers to the temperature regulation blocks; and
a control unit configured to control the arm based on a temperature regulation block to which a reaction container is input and a timing of the input,
wherein, when the reaction containers are continuously installed to the temperature regulation blocks, temperatures of the temperature regulation blocks to which the reaction containers are installed are controlled with the first temperature regulation devices according to temperature control protocols determined according to measurement items of the reaction containers, and
a selection of a position of the temperature regulation block to which a next reaction container of the reaction containers is installed is controlled depending on a number of temperature variations with increase and decrease in temperature according the temperature control protocols of the temperature regulation blocks in the past.

11. The nucleic acid test apparatus according to claim 9, wherein an alarm is generated when a difference between numbers of implementations of the temperature control protocols of the temperature regulation blocks in the past is equal to or larger than a predetermined number.

12. The nucleic acid test apparatus according to claim 10, wherein an alarm is generated when a difference between numbers of temperature variations with increase and decrease in temperature according to the temperature control protocols of the temperature regulation blocks in the past is equal to or larger than a predetermined number.

13. The nucleic acid test apparatus according to claim 1, further comprising: a plurality of temperature measurement units on the holder base holding the temperature regulation blocks.

14. The nucleic acid test apparatus according to claim 1, wherein, when the first temperature regulation device is a Peltier device and the Peltier device is placed while a first surface of two heat exchanger surfaces of the Peltier device coheres with the temperature regulation block and a second surface coheres with the holder base,
the second temperature regulation device and at least one of the first temperature regulation devices control the holder base to bring the holder base to a desired temperature.

15. The nucleic acid test apparatus according to claim 14, wherein, before each of the first temperature regulation devices individually controls a temperature of each of the temperature regulation blocks,
the second temperature regulation device and at least one of the first temperature regulation devices control the holder base to bring the holder base to a temperature lower than a temperature range in which the temperature regulation blocks are to be controlled.

16. The nucleic acid test apparatus according to claim 14, wherein, before each of the first temperature regulation devices individually controls a temperature of each of the temperature regulation blocks,
the second temperature regulation device and at least one of the first temperature regulation devices control the holder base to maintain the holder base at a temperature within a range of an upper limit and a lower limit of a temperature in which the temperature regulation blocks are to be controlled.

17. The nucleic acid test apparatus according to claim 14, wherein, before each of the first temperature regulation devices individually controls a temperature of each of the temperature regulation blocks,
the second temperature regulation device and at least one of the first temperature regulation devices control the holder base to bring the holder base at a temperature higher than a temperature range in which the temperature regulation blocks are to be controlled.

18. (canceled)
